(19) United States
(12) Patent Application Publication
(10) Pub. No.: US 2004/0076775 A1
(43) Pub. Date: Apr. 22, 2004

(54) Method and composition for a durable in-mold label

(76) Inventor: Jean Pierre Giraud, Paris (FR)

Correspondence Address: GREENBERG TRAURIG, LLP, 885 3RD AVENUE, NEW YORK, NY, 10022, US

(21) Appl. No.: 10/274,324

(22) Filed: Oct. 18, 2002

(51) Int. Cl. F16L 1/00

(52) U.S. Cl. 428/34.1

(57) ABSTRACT

A molded container assembly provided with a label formed in the mold, wherein the container passes the dishwasher test, comprised of a container body having a wall, a label attached to the wall, the label including an upper varnish layer covering an ink layer and a primer layer, the varnish layer, ink layer and primer layer being applied to a substrate layer, wherein the varnish layer, adhesive layer, and ink layer are present in amounts effective to insure the label passes the dishwasher test.

### FIELD OF THE INVENTION

The present invention is a directed to a container provided with a label formed in the mold, and method for producing same. When attached to the container, the label exhibits durability, so that when subjected to conditions that would be expected to cause the removal of the label, or portions thereof, it instead exhibits an extended useful life.

### SUMMARY OF THE INVENTION

The present invention is a directed to a container provided with a label formed in the mold, and method for producing same. By “label formed in the mold” the applicant is referring to a label that is formed at the time the container is formed, such as by blow molding or injection molding. When attached to the container, the label is durable, meaning that it exhibits an elevated level of wear resistance. When the label is exposed to conditions that would be expected to cause the removal of the label, or portions thereof, the label offers resistance to removal, for at least a period of time. Thus, the useful life of the label is extended. In a specific example, the label's durability is evidenced by a favorable outcome in the dishwasher test, in which the label remains on the container, after numerous wash cycles in a dishwasher. Dishwashers are known to cause the removal of labels when the item to which the label is adhered washed repeatedly in the dishwasher.

In one embodiment, the container is provided with a label that is formed in the mold. The label exhibits increased durability. In another embodiment, the container is provided with a label formed in the mold, wherein the label exhibits increased durability, and wherein the label is constructed of a plurality of layers. In yet another embodiment, the label is formed of any one of a number of label forming methods, including reverse print, lamination, and standard methods.

In one embodiment, the label is attached to the outside of the container. In another embodiment, the label is attached to inside of the container. In this embodiment, the container is formed of a clear polymeric material, so that the label is visible from outside of the container.

### BRIEF DESCRIPTION OF THE DRAWINGS

FIG. 1 is a schematic depicting the layers of the label of a first embodiment.

FIG. 2 is a schematic depicting the layers of the label of a second embodiment.

FIG. 3 is a schematic depicting the layers of the label of a third embodiment.

### DETAILED DESCRIPTION OF THE INVENTION

In the embodiments of the present invention, the labels which are to be applied include at least one of text and graphics (and in many cases, both) which are applied to a substrate. The substrate may be a layer of transparent, translucent, or “contact clear” substrate that is formed from a polymer or mixture of polymers. The substrate is substantially flat and planar, and may have a thickness between about 0.002 and about 0.008 inches. The substrate has a print receiving side, on which text and graphics are printed, and a container contacting side. In one embodiment, the substrate might have a specific gravity that is substantially the same as the specific gravity of the polymer or polymer mixture from which it the substrate is formed. In another embodiment, the substrate can have a coefficient of thermal expansion/contraction that is substantially the same as the coefficient of the polymer from which the container is made. In a further embodiment, the label substrate is regrind compatible with the polymers from which the container is made.

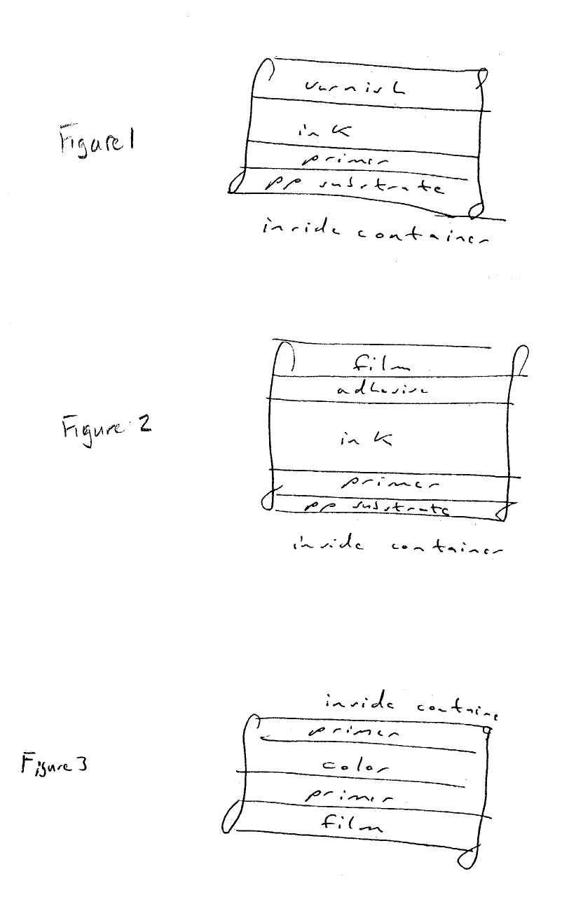

Using one or more inks, text and graphics are printed on the print-receiving side in accordance with well-known printing techniques. In one embodiment, a primer is applied to the substrate prior to printing on the substrate. After the ink layer has been applied over the primer layer, a varnish is applied over the ink layer. The substrate is attached to the container, with the label facing outward. This arrangement is shown in FIG. 1.

In yet another embodiment, a primer is applied to the substrate prior to printing on the substrate. After the ink layer has been applied over the primer layer, a layer of adhesive is applied over the ink layer. A film is then adhered to the adhesive layer. This arrangement is shown in FIG. 2.

In yet another embodiment, a primer is applied to the substrate prior to printing on the substrate. After the ink layer has been applied over the primer layer, a second layer of primer is applied over the ink layer. This embodiment is suited for reverse label applications in which the label is applied to the inside of the container, with the label facing outward. This arrangement is shown in FIG. 3.

In yet another embodiment, during preparation of the labels, the non-printing side of the substrate can be coated with an anti-static composition, or such a composition can be co-extruded onto the substrate as a separate layer. Additionally, or alternatively, a slip composition can be provided on the non-printing side of the substrate.

Labels can be mass-produced either as sheets or as rolls, from which individual labels are cut and stacked according to known techniques.

In one example of a blow molding process, a label is taken from the stack of labels and is placed in the mold, either by an automated process or by hand. The label is held in the proper position either by vacuum or by static electricity. A parison—a semi-solid, molten plastic tube—is placed between the mold halves and the mold is closed. Air is injected into the parison, forcing it to take the shape of the mold cavity, which is the shape of the container. This forces the label to stretch and to take the shaped of the cavity relief or part contour by the plastic parison. Heat from the parison effects a bond between the label and the molded container part.

The material used to construct the container and the layer that contacts it should be compatible with each other. Concerning this, suitable substrate materials include polypropylene, among other materials. Suitable primer composition include, but are not limited to, a product identified as 12RI Ref. 806885, available from Siepa, S. A. of Annemasse, France. Suitable inks include, but are not limited to, products available from Trespaphan GmbH of Neunkirchen, Germany a subsidiary of Hoescht. Suitable varnish include, but are not limited to, products from Sicpa, S. A. of Annemasse, France, identified as product number 036762. Inks are also available from Sicpa.

Suitable adhesive material include, but is not limited to, the Dargoflex UV plastic films 39-0-0147 laminating adhesive, available from SICPA-AARBERG AG, Aarberg, Switzerland.

Suitable film material include, but are not limited to, a product manufactured by Steinbeis Packaging, Film Division, Type: ETR 57 (material: polypropylene) with a thickness of about 25 to about 40 μm, more particularly 32 μm. In one example, the film has a density of about 0.91. The film is substantially transparent.

One of the advantages of the present invention is that the attached label exhibits wear resistance, and is capable of withstanding repeated washings in a dishwasher without wearing away.

For purposes of the present invention, the “dishwasher test” is a test carried out according to the following procedure. A Kenmore Ultra Wash Dishwasher is used. Put the container on the shelf in the dishwasher.

a) Fill dishwasher detergent receptacle with Cascade Powder Detergent (Regular Strength).

b) Set dishwasher for Natural Cycle and run the dishwasher for the complete cycle duration (wash and dry). At the completion of the cycle, open dishwasher door and allow parts to cool for an additional 10 minutes.

c) Repeat Steps 2 and 3 for at least ten cycles.

d) After all cycles are complete, remove all parts and allow them to cool in air at room temperature for a minimum of 1 hour before proceeding with functional testing.

The label “passes the dishwasher test” if the label passes the following test. For this test, cellophane tape (3M #610) 1” wide is used. The tape is conditioned to standard room conditions (45-50% Rh and 70F+/−5 degrees). A fresh strip of tape is applied over the test area. A moderate pressure is applied to ensure adequate adhesion (avoid bubbles, wrinkles or creases). The tape is pulled from the test area with fast motion at about 150 degree angle, being careful not to rupture the base structure. If delamination occurs, the sample fails the dishwasher test. The tape and the test sample is then examined for transfer of ink. The sample is then visually rated from 1-10 according to the percentage of ink remaining where the tape came into contact with the sample surface. For example, if 40% remains on the test sample then the rating is a “4.” A failure is anything less than a “9.5” (i.e. 95%).

In one embodiment, the label is applied to the inside wall of a transparent container. For this arrangement, in one example, the in-mold labeling process is performed by inserting a label within an open mold prior to closing of the mold around an extruded hot plastic tube or a heated injection molded plastic preform. For example, the label can be the same shape as the molded plastic (e.g. the label insert can be a cylindrical shape with a closed bottom that is inside a comparably shaped cylindrical container). Subsequent mold closing and extrusion forms the hot plastic around the label to the shape of the mold. Also, such in-mold labeling provides a smooth transition between the label and the adjacent surface of the container and may further provide additional strength since the label cooperates with the container wall in resisting deformation. Such strengthening may allow the use of less plastic to blow mold the container and thereby reduces the ultimate cost to the consumer.

Examples of suitable substrates include, but are not limited to, paper-like materials and thermoplastic materials including polyolefins such as polypropylene and polyethylene, polyisoprene, polybutadiene, polybutene, polysiloxane, polycarbonates, polyamides, ethylene-vinyl acetate copolymers, ethylene-methacrylate copolymer, poly(vinyl chloride), polystyrene, polyesters, polyanhydrides, polyacrylianitrile, polysulfones, polyacrylic ester, acrylic, polyurethane and polyacetal, or copolymers or mixtures thereof.

In one embodiment, the label is prepared for input into the system (e.g. a roll or stack of material). In the next step, a robotic arm or other mechanism that can properly place the label in the mold (e.g. “a pick and place”) is employed. The mechanism picks-up the label and positions the label in the mold apparatus having transfer heads that engage and move the labels. For example, transfer heads are connected to a drive mechanism that cycle the heads back and forth between a label pick up position and a label transfer position. The heads carry vacuum cups for engaging and holding the label. When in the label pick up positions, the heads are moved against labels to form vacuum connections with the labels. Movement of the heads away from the pick up position pulls the labels. The labels are carried with the heads for subsequent placement in cavities in the mold sections.

In one embodiment, the label is placed on the core. The label may be held in place in the mold by conventional methods known in the art such as suction or charging the film with static electricity or any combination of methods. Subsequently, the mold closes and plastic is injected into the mold. The mold then opens and the molded part is ejected with the label attached to the plastic.

In a further embodiment, the label can be secured to the core by first applying the label to the core and then employing hot air to slightly shrink the polymeric liner to the core.

In embodiments relating to the geometrical shape of the label prior to placing the label in the mold, the label may be sized so that each label is the size of the circumference of the surface where the label will be placed. For example, if the label is placed in the inside of the container then the label may be sized so that the label is equivalent to the size of the inside circumference of the container. If the label is placed in the outside of the container then the label may be sized so that the label is equivalent to the size of the outside circumference of the container. In another example, if the container is not cylindrical, then the label is sized so that the label has the equivalent size and shape of, if placed on the inside surface of the container, the inside shape of the container, and/or, if placed on the outside surface of the container, the outside shape of the container.

In yet another embodiment relating to the geometric shape of the label prior to placing the label in the mold, the label is formed as a tube-like shape (e.g. the label is extruded in the form of a tube-like shape). In one example, the continuous tube from the extruder is cut to conform to the size of the desired container. Subsequently, the label is placed on the core and the plastic is then injected into the mold. As a result, an in-process sleeve processed in employed.

In yet another embodiment, a printed film can be co-laminated to the label prior to placing in the mold. Alternatively, two or polymeric materials may be co-laminated to form a laminated label.

In one embodiment, the present invention may be employed with a “rotating table” injection molding equipment. For example, in a first position, a first label of the present invention is first placed on the core. The core is rotated to a second position where the mold is closed and a first plastic composition is injected in the mold over the first label. The mold is then opened and the core is rotated to a third position where a second label is placed over the core containing the injection molded plastic composition and the first label. The second label may be composed of the same material as the first label or may be composed of a different material than the first label. The core is then rotated to a fourth position where the mold is closed and a second plastic composition is injected in the mold. The second plastic composition may be composed of the same material as the first plastic composition or may be composed of a different material then the first plastic composition. The mold is then opened and the multi-layered material is then ejected from the mold.

In another embodiment, the label is inserted into open mold cavities in a matter of fractions of a second prior to the mold halves closing about a core to produce a desired container. Each label is laid against its respective mold cavity wall and held therein as it closes. In one example, a supply of air is blown into the resin therein to make it conform to the mold contours with the label on the cavity wall being correspondingly molded upon the resinous container wall.

In one example, when labels are supplied to the mold, (e.g. one to each mold half), a mechanical or other suitable method of inserting and applying the labels to the walls of the open halves is provided which must act sufficiently quickly before the two halves close otherwise imparting a time delay in the molding cycle. Since it is important for efficiency of operation that the plastic flow from the extruder not be interrupted, the time available is limited for insertion of labels on the walls of the mold halves without incurring a delay in the production cycle. This requires rapid action by the mechanism for inserting the labels on the walls of the mold halves. That is, the label inserter must get in between the mold halves quickly while they are open and get out quickly before the space between the closing mold halves becomes too small for the mechanism to be safely present therein.

In one example, the mold cavities (e.g. holes of about 0.002 inch diameters) are each provided with spaced small masked openings at which a negative pressure is provided by connection of the mold half to a negative pressure source. By this means when a label is inserted in the cavity, the spaced negative pressure spots act to receive the label from a label carrying mechanism and to hold the label against the interior wall of the cavity. The label carrying mechanism is thereupon withdrawn from the cavity region of the mold. A negative pressure is established in a manifold. The manifold may be a conventional pressurized air flow manifold which generates a negative pressure. During movement to the pick up positions, the labels may be rotated to assure proper angular orientation when picked up by the in-mold label apparatus for placement in the mold sections. In one example, vacuum ports in suction cups of the pick up mechanism are continuously connected to a low vacuum source through vacuum manifold.

In another embodiment of placing the label into the mold, a robot hand apparatus applies a label into a mold with a static electricity generating apparatus for generating static electricity on a holding surface. For example, this static electricity generating apparatus may comprise a holding member attached to one side of a platelike base continuous with an arm of a robot and having a holding surface with substantially the same shape as that of the label on the side opposite to the side where the label is attached, tungsten wires stretched in grooves opened on the side of the holding surface in the holding member using securing members, high-voltage cables with static electricity shields that are connected to the tungsten wires and are led to a high-voltage power source, and a plurality of suction holes opened perpendicularly to the holding surface of the holding member and connected to a vacuum generating source. The electrostatic generating apparatus attracts the label to a robot hand attracting surface by negative pressure, moves the robot hand in place in the mold, gives static electricity to the label by the static electricity generating apparatus of the robot hand before and after the movement, and applies the label into the mold.

What is claimed is:

1. A molded container assembly provided with a label formed in the mold, wherein the container passes the dishwasher test, comprised of a container body having a wall, a label attached to the wall, the label including an upper varnish layer covering an ink layer and a primer layer, the varnish layer, ink layer and primer layer being applied to a substrate layer, wherein the varnish layer, adhesive layer, and ink layer are present in amounts effective to insure the label passes the dishwasher test.

2. A blow-molded container assembly provided with a label formed in the mold, wherein the container passes the dishwasher test, comprised of a container body having a wall, a label attached to the wall, the label including an upper film layer adhered over an ink layer with an adhesive, and a primer layer; the film layer, ink layer and primer layer being applied to a substrate layer, wherein the film layer, adhesive layer, and ink layer are present in amounts effective to insure the label passes the dishwasher test.

3. A molded container assembly provided with a label formed in the mold, wherein the container passes the dishwasher test, comprised of a container body having a wall, a label attached to the wall, the label including a upper and lower primer layers which sandwich an ink layer, the upper and lower primer layers and ink layer being applied to a substrate layer, wherein the upper and lower primer layers and ink layer are present in amounts effective to insure the label passes the dishwasher test.

4. The molded container assembly of claim 3 wherein the wall of the container body has an inner side and an outer side, and wherein the label is attached to inner side of the container.
